(19) United States
(12) Patent Application Publication
(10) Pub. No.: US 2017/0047994 A1
(43) Pub. Date: Feb. 16, 2017

(54) VISIBLE LIGHT AND POWER-LINE COMMUNICATION-BASED SYSTEM WITH LOCATION-BASED SERVICES

(71) Applicant: STMicroelectronics, Inc., Coppell, TX (US)

(72) Inventor: Oleg Logvinov, Jersey City, NJ (US)

(21) Appl. No.: 15/230,227

(22) Filed: Aug. 5, 2016

Related U.S. Application Data
(60) Provisional application No. 62/203,192, filed on Aug. 10, 2015.

(51) Int. Cl. H04B 10/116; H04B 3/54; H04W 4/00; H04W 4/02; H04L 29/08; G06Q 30/02

(52) U.S. Cl. CPC H04B 10/116; H04L 67/303; G06Q 30/0267; H04W 4/008; H04W 4/021; H04B 3/54

(57) ABSTRACT

A hybrid communications network system uses the propagation limitations of Visible Light Communications (VLC) to define location data for portable VLC devices. The location data can be used with specific location-based profiles to provide location-based services to functional zones. The hybrid communications allow location data and connectivity to be available among other communications technologies on the hybrid network.

### TECHNICAL FIELD

The present disclosure generally relates to networking systems. More particularly, the present disclosure relates to a system and method using signal propagation limitations of a Visible Light Communications (VLC) network physical layer.

### DESCRIPTION OF THE RELATED ART

A wide variety of communications networks for communicating data (including isochronous audio and video data) are available. These communications networks can include wired networks such as Power-Line communications (PLC) (e.g., IEEE 1901-2010), wireless radio frequency (RF) communications (RFC) such as Wi-Fi (e.g., various IEEE 802.11 versions), and wireless visible light communications (VLC) (e.g., IEEE 802.15.7-2011). Certain standards, such as IEEE-1905.1-2013 and its associated amendment, P1905.1a, provide an abstraction protocol that supports non-interoperable networks, such as Wi-Fi, IEEE 1901, Multimedia Over Coax Alliance (MoCA), and others to communicate by bridging across the layer 2 and 3 open systems interconnect (OSI) model protocol layers, above their specific communications media access control (MAC) and physical (PHY) protocol layers.

In communications networks, including those mentioned above, the content, control, and function of the data being distributed, and the efficient communication of the data with respect to power, bandwidth, or other characteristics, can be controlled using location data information associated with the location and motion of a portable receiver, a transmitter, or a transceiver device. Some systems, such as, but not limited to, photography, television, and electronic games may also use detailed information about the azimuth, altitude, rotation, and velocity of the portable receiving device.

Wired networks generally lack mobility, and so a wired network is typically associated with a single location. RF wireless systems can be portable, but their signals are less reliable since they sometimes pass through walls and objects and other times reflect off walls and objects. Wireless signals may be used to locate objects in space; however, identifying the location of a device in a specific physical zone within a building (e.g., in-room) where the room's boundaries are relatively transparent to RF is much more difficult. This type of location identification of a device in a specific physical zone also requires mapping the device location to the premise's zone locations.

Other methods of locating devices in space to provide location-based service are known. For example, some techniques have used RFID tags. However, the range of an RFID tag is limited. Additionally, reading an RFID tag requires a second system (i.e., a host RFID reader) in addition to the access point communication system. Laser systems, imaging systems, and other “in-room” light-based location technologies in the THz frequency range have been tried to prevent signal propagation through solid objects such as zone walls and people; however, these technologies are also separate from the communications system and increase the cost and complexity of the system.

In prior technologies, there was no known communication system for portable devices that (1) support device location using acquired location data in a transmission zone within physical boundaries (e.g., walls and floors), and (2) support network communications that enable a controller, portable devices, and/or devices and software applications with access to a network, to make use of the acquired location data.

Notably, all of the subject matter discussed in this section is not necessarily prior art and should not be assumed to be prior art merely as a result of its discussion in this section. Accordingly, any recognition of problems in the prior art discussed in this section or associated with such subject matter should not be treated as prior art unless expressly stated to be prior art. Instead, the discussion of any subject matter in this section should be treated as part of the technical solution to a particular technical problem, which in and of itself may also be inventive.

### BRIEF SUMMARY

A network system may be summarized as including a network node; at least one Visible Light Communications (VLC) portable device; and a network interface coupled to the network node, the network interface including a VLC access point configured to receive light-based information from the at least one VLC portable device, wherein the VLC access point is further configured to determine location data about the at least one VLC portable device from the light-based information, wherein the network node is configured to receive the location data, and wherein a parameter of the network system is modified in response to the location data.

A plurality of VLC networks may share a common location profile, the common location profile defining a transmission zone and the common location profile directing operations of portable devices when any of the VLC portable devices are communicatively associated with any of the respective VLC networks. A VLC-based profile for a first area may logically be combined with another VLC-based profile for a second area during a provisioning process, wherein each VLC-based profile may stipulate data associated with its respective area.

A concatenation of VLC-based profiles with non-VLC-based profiles may form a hybrid technology network that permits broader transmission zones and capabilities coverage than only combining VLC-based profiles. A VLC-based profile may be configured to enable a VLC portable device to access confidential data or restricted services due to the VLC portable device being verified to be in an area by an associated VLC access point. Access to the confidential data or restricted services by the VLC portable device may be withdrawn when the VLC portable device leaves the area.

An associated VLC profile may pass local content from a store having a VLC access point to a VLC portable device when the VLC portable device is in proximity of the store. The local content may include menus, advertisements, directories, promotions, coupons, inventory lists, store hours, listing of upcoming events, or combinations thereof. The VLC network system may classify all communications inside an area as secure after confirming a location of a VLC portable device in an area using a VLC access point. The VLC network system may modify network parameters for a VLC portable device after confirming a location of the VLC portable device in an area using a VLC access point. The network parameters may include bandwidth priority, Quality of Service (QoS), prioritization (CoS), or combinations thereof. The VLC network system may modify parameters for a VLC-enabled portable device after confirming a location of the VLC-enabled portable device in an area using a VLC access point, wherein the modified parameters include service suspension of a smartphone, ringer disablement of a smartphone, restriction of permissible communication types of a smartphone, or combinations thereof. After confirming a location and movement of a VLC-enabled portable device in an area, the VLC network system may perform one or more actions in the area, including turning lights on or off, opening or closing doors, opening or closing windows, adjusting a temperature on a heater or air conditioner, or combinations thereof. The VLC network system may generate an alert for health professionals after confirming a lack of movement in an area of a VLC-enabled portable device. The VLC network system may transmit biological data to network applications after confirming a lack of movement in an area of a VLC-enabled portable device.

A plurality of hybrid networks may be interconnected by an IEEE 1905.1-enabled backbone network, wherein the plurality of hybrid networks may share a common location profile, and wherein operations of the VLC portable devices associated with different access points in the plurality of hybrid networks may be directed by the common location profile.

A plurality of hybrid networks may be interconnected by an IEEE 1905.1-enabled backbone network, wherein the plurality of hybrid networks may share common location data, and wherein location-based services and data may be distributed based on the common location data. The network interface may supply an IEEE 1905.1 protocol, a Power-Line broadband communications technology protocol, an Ethernet broadband communications technology protocol, a wireless Ethernet broadband communications technology protocol, or combinations thereof. A VLC light emitter/receiver may be integrated in a light bulb, a television backlight, a cell phone backlight, or a portable computing device backlight. The VLC access point may be in communication with an Internet backbone interface. The system may include a VLC beacon communicatively associated with the VLC access point, the VLC beacon configured to emit a VLC signal identifying the VLC beacon to the at least one VLC portable device. The system may include a VLC beacon communicatively separated from the VLC access point, the VLC beacon configured to emit a VLC signal identifying the VLC beacon and associated VLC beacon location data to the at least one VLC portable device. The location data may enable identification of a physical transmission zone. The location data may enable movement detection of the at least one VLC portable device within a physical transmission zone. The location data may enable indicates location information associated with the at least one portable VLC device, and wherein the location information may include a location in a transmission zone, a direction of a movement, a velocity of the movement, an orientation, or combinations thereof, wherein the orientation may include rotation, azimuth, and altitude.

A network system may be summarized as including a network node; a network interface coupled to the network node, the network interface including a Visible Light Communications (VLC) access point; and at least one VLC portable device, wherein the at least one VLC portable device is configured to determine location data using light-based information from the VLC access point, wherein the VLC portable device is further configured to communicate the location data to the network node, wherein the network node is configured to communicate the location data to a software application.

A method of providing location based services using a network system may be summarized as including providing a network node and a plurality of Visible Light Communications (VLC) portable devices; communicatively associating a network interface with the network node, wherein the network interface includes a VLC access point; receiving light-based information from at least one of the plurality of VLC portable devices via VLC access point; determining location data about the at least one VLC portable device from the light-based information via VLC access point; communicating the location data to the network node; and modifying a parameter of the network system in response to the location data.

The signal propagation limitations of light define a VLC transmission zone. The transmission zone is represented with a profile that directs or otherwise determines certain location-based services that are available when an associated portable device is within one or more of three dimensional zones. Furthermore, a VLC network system may be used to precisely locate a mobile VLC device within a three dimensional space. As such, the VLC network system may generate additional location information that can be provided to any number of computing devices. In one embodiment, the VLC network system is used in conjunction with other wired and/or wireless networks to create a hybrid network that can utilize various capabilities of the hybrid-network.

In some embodiments, a visible light communications (VLC) network has one or more VLC networked portable device(s) and one or more access points. In another embodiment, a VLC controller is also part of the VLC network system. Each access point provides access from a portable VLC device to a communications backbone. The location of each access point may be referred to as a Hot Spot. In some embodiments, each VLC access point is deployed in a VLC transmission zone that is bounded by physical barriers to visible light. The physical barriers limit the possible locations of a portable VLC device on the network. For example, a portable VLC device may be limited to placement within a room or other structure of barriers.

Due to the limitations that are characteristic of the signal propagation of visible light, association (i.e., communicative network membership association) with the VLC access point, the VLC access point can confirm that a portable device is located within view of the VLC access point's location since the light signal does not traverse physical barriers. Otherwise stated, association with a VLC access point located in a conference room confirms that the VLC access point, and each portable device associated with the VLC access point, is in the conference room.

In one embodiment, the VLC access point transmits location information to a VLC-enabled portable device. Simply stated, the VLC access point instructs the VLC-enabled portable device, “You are associated with the access point ID#xxx in Conference Room A.” In this embodiment, the VLC-enabled portable device determines if this portable device location information is acceptably accurate. Additional portable device location information may include determination of location, azimuth, altitude, rotation, or combinations thereof.

In another aspect, the portable device location information may also include information about other devices on the network. In such an embodiment, the portable device location information may identify which access points a portable device is communicatively associated with or can be communicatively associated with. Continuing, the portable device location information may further identify a relative location of the portable device to one or more of the VLC access points. For example, the portable device communicatively “sees” AP1, AP2 and AP3, and the portable device knows where it is in relation to the three access points.

In addition to using VLC for communication, the access points may also communicate between barriers or to other locations through a backbone and other networks on the backbone, or to network devices or software applications that can access the backbone (e.g., via the Internet).

In some embodiments, a VLC transmission zone is represented by a name or some other identifier. The name may represent a recognizable transmission zone such as “room,” “conference room,” or “lobby.” It may also represent a function such as “secure area” or “public access area.” Use of the location data is defined by or otherwise determined by a profile.

These features with other technological improvements, which will become subsequently apparent, reside in the details of construction and operation as more fully described hereafter and claimed, reference being made to the accompanying drawings forming a part hereof.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. The figures do not describe every aspect of the teachings disclosed herein and do not limit the scope of the claims.

FIG. 1 is a block diagram of a hybrid network system with VLC, RFC, and PLC communications elements;

FIG. 2 illustrates the propagation of VLC, RFC and PLC devices with respect to the walls of a building;

FIG. 3 illustrates various examples of the collection and use of location data.

### DETAILED DESCRIPTION OF ILLUSTRATIVE EMBODIMENTS

Persons of ordinary skill in the art will understand that the present disclosure is illustrative only and not in any way limiting. Other embodiments of the presently disclosed system and method readily suggest themselves to such skilled persons having the assistance of this disclosure.

Each of the features and teachings disclosed herein can be utilized separately or in conjunction with other features and teachings to provide a VLC Network System Employing Location-Based Services. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” “configuring,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present application also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

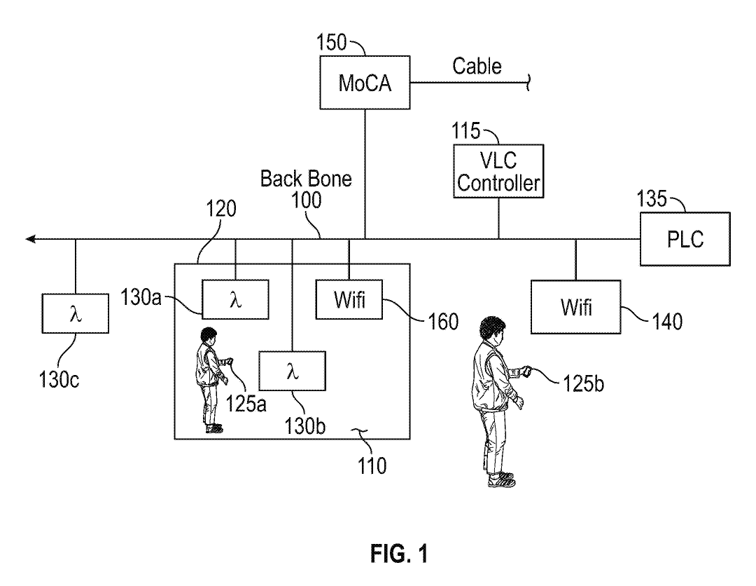

FIG. 1 is a block diagram of a hybrid network system with visible light communications (VLC) elements, wireless RF communications (RFC) elements, and Power-Line communications (PLC) elements. In one embodiment, the hybrid network system includes a communications backbone 100, a VLC controller 115, and a VLC network that provides VLC signals in a VLC transmission zone 110 within a room 120 using VLC access points 130. Specifically, the embodiment of FIG. 1 shows a VLC Network System that employs location based services. The VLC network system that includes one or more VLC-enabled portable device(s) 125 and one or more VLC access points 130. In some embodiments, a VLC controller 115 also may be part of the VLC network and in communication with the VLC network components. The VLC access points 130 provide access to the communications backbone 100 by the VLC-enabled portable devices 125. As shown in FIG. 1, the VLC access points 130a and 130b are deployed within a transmission zone 110 that is bounded by physical barriers to visible light, such as the walls of room 120.

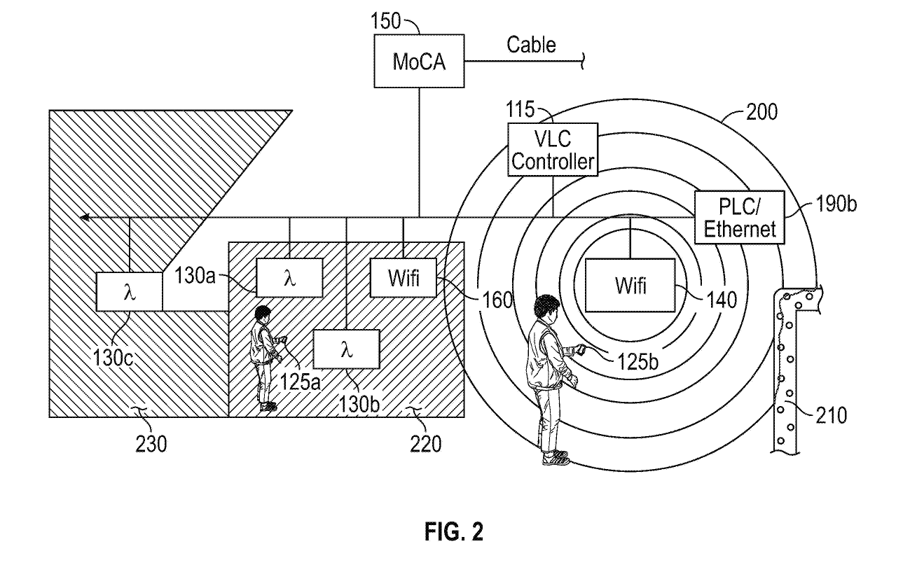

FIG. 2 illustrates the signal propagation of VLC, RFC and PLC devices as the signals interact with the walls of a building. Specifically, FIG. 2 displays the physical communications limits for specific technologies with respect to the physical surrounding. For example, Wi-Fi is a particular RF technology that can propagate signals 200 through ceilings, floors, and walls, including the walls of the room 120 shown in FIG. 2. However, RF signal penetration issues and RF signal reflection issues exist with respect to signal interaction with some denser materials, such as metal duct work (not shown) or concrete walls 210. The nature of the materials in a particular physical surrounding and how the materials in a particular physical surrounding will affect the RF signals is typically not foreseeable with sufficient certainty. Additionally, performing research regarding RF signal penetration/reflection issues and the materials in a particular physical surrounding can be problematic and expensive. Thus, even if the portable device 125b is shown FIG. 2 is able to associate with either Wi-Fi access point 140 or Wi-Fi access point 160, the Wi-Fi technology is not able to determine the exact location of the portable device 125b with respect to barriers such as the walls of room 120 (i.e., the Wi-Fi technology is not able to accurately determine if the portable device 125b is inside or outside of room 120).

Referring now to wire-based technologies, such as Power-Line communications or Ethernet, these wire-based technologies comply with a wire-based protocol such as Multimedia Over Coax Alliance (MoCA). Continuing, these wire-based technologies use the communications backbone 100 and often employ a broadband communications technology (e.g., Power-Line communications, Ethernet, and the like). The range of effective use for a portable device using wire-based technologies is limited by the location of physical wiring and interface connectors in the room or other area in which the physical wiring and interface connectors are deployed. The location of the wired terminals can be designed in the room so that there is a one to one correlation between wired terminals and a location. However, this design configuration is very constricting, and it does not enable modifications to be made once a room is wired.

In one embodiment of the VLC Network System that employs location based services, the connectivity range for a VLC-enabled portable device 125a (which employs VLC signal transmission) is limited by any type of opaque barriers (including the walls of room 120). In FIG. 2, the cross-hashed operating signal propagation space 220 for VLC signals is limited to internal transmission zone 110 within the room 120. In this arrangement, the VLC-enabled portable device 125a within the room 120 communicatively associates with the VLC network via access points 130a or 130b (which are inside the room 120), but not with VLC access point 130c (which is outside of the room 120). Consequently, the location of the VLC-enabled portable device 125a may be conclusively determined to be within the room 120. Likewise, any device that associates with VLC access point 130c, which is in a different room (e.g., a foyer), may be conclusively determined to be located within transmission zone 230 (which is associated with VLC access point 130c). In some embodiments of the VLC Network System that employs location based services, since the VLC access points 130a, 130b, 130c are in communication with the communications backbone 100, the VLC access points 130a, 130b, 130c concatenate their transmission zones by sharing the list of devices associated with each other.

In one embodiment of the VLC Network System, VLC-enabled portable devices in transmission zones 220, 230 may be logically considered to be in the same network and combined by software applications or a network node 115 (e.g., network controller, network controller-based device, or the like) into one transmission zone with the same location profile (e.g., a location data set called “room and foyer”). In such an embodiment, the VLC-enabled portable devices in these different transmission zones appear to be in the same transmission zone. As such, these VLC-enabled portable devices can share a same profile. In some embodiments of the VLC Network System, a profile is a set of parameters that determine the characteristics of a location, a signal transmission zone, or some other zone. Some parameters of a profile include quality of service (QoS), security, allowed features, billing data, other information, or combinations thereof. In one implementation, a VLC-enabled portable device is located in a conference room. Once the VLC-enabled portable device is verified to be in the conference room by the VLC access point, the associated profile may be configured to enable the VLC-enabled portable device to access confidential data or otherwise enable access to previously restricted services or information. Continuing, in some implementations, when the VLC-enabled portable device leaves the room, then the permission (and ability) to access the confidential data (or other restricted services or information) is withdrawn.

In another embodiment of the VLC Network System, if the VLC-enabled portable device pauses in front of a store, the profile permits local content from the store, such as menus, advertisements, or other information to be passed to the VLC-enabled portable device.

In some embodiments of the VLC Network System, a VLC-enabled portable device may have multiple profiles or a comprehensive profile that has many portions. In some implementations, different users of the VLC-enabled portable device have separate profiles. In another aspect, there may also be different types of profiles, e.g., one profile for the VLC-enabled portable device and a different profile for the VLC Access Point. In still another aspect, profiles may be defined to describe capabilities of the device (e.g., portable device, access point) or user preferences.

In many embodiments of the VLC Network System, the concatenation of transmission zones and profiles is very flexible, and may be performed for any number of VLC networks or in conjunction with mixed hybrid communication technologies. For example, a profile for a conference room may also be logically combined with the profile for the lobby, which provides a way to specify only the data specific to the area. The ability to combine “standard” profiles provides a technological improvement to the provisioning process. In this embodiment, access to other transmission zones, other technologies, the internet, or combinations thereof, is provided through the communications backbone 100. In this manner, the concatenation of VLC-based profiles with the profiles of other technologies and coverage areas forms a hybrid technology network that permits broader transmission zone and capabilities coverage.

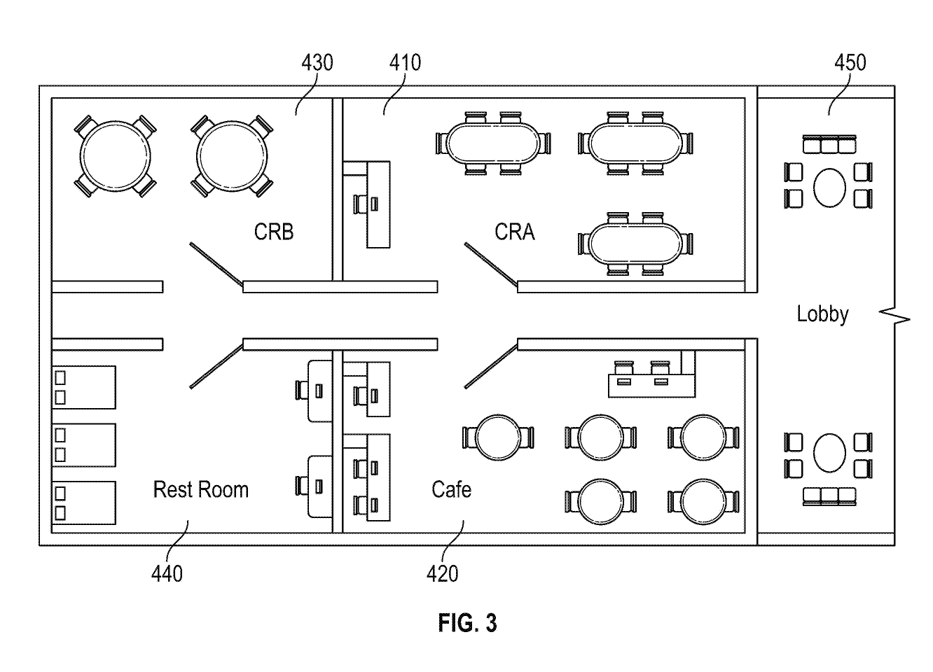

Referring now to FIG. 3, various examples of the collection and use of location data by the VLC Network System are shown. Location data can be used in a variety of ways by the VLC Network System. In the embodiment of FIG. 3, some areas are shown that may benefit from, or require separation of, data access by function with respect to a location of a VLC-enabled portable device.

In one implementation, Conference Room A 410 represents a confidential meeting transmission zone. In the interest of security, a VLC communications system may be used to avoid out-of-room radiation of wireless communications signals that may contain confidential information such as voice-over-Internet-protocol (VOIP) discussions, wireless microphone data, presentations, or other confidential data. In addition, by virtue of being associated with the VLC Network System of Conference Room A 410 (using VLC signal transmission), all VLC-enabled portable devices located in Conference Room A 410 are verified as being in a secure zone. The confirmation of this location information using VLC signal transmission enables the VLC Network System to treat all communications inside Conference Room A 410 as secure. The confirmation of this location information may also provide other network parameter benefits, such as giving bandwidth priority to Conference Room A 410 over other locations such as the cafeteria 420 or other meeting rooms 430. Other network parameter benefits provided using the confirmation of location information include Quality of Service (QoS), prioritization (CoS), and the like.

FIG. 3 illustrates an embodiment of VLC Network System in which any VLC-enabled portable device located in the rest room 440 may have its service suspended, ringer turned off, or type of permissible communications (e.g., text messaging) switched to another level. This capability of the VLC Network System enables the occupants in the rest room 440 to not be distracted by, for example, suspending service to the VLC-enabled portable device. In another aspect of the VLC Network System, other VLC-enabled portable devices, such as those of users in the lobby transmission zone 450, may be governed by a profile that permits location-based access to guest services, such as Internet and a building phone directory, but otherwise locks access to the Internet.

In some embodiments, applications that use the location data may be executed in a VLC networked portable device 125, a network node 115, or in some other computing device or system accessible to interfaces of the communications backbone 100.

A VLC networked portable device 125 may be in communication with the communications backbone 100, as previously discussed in reference to FIG. 1. The communications backbone 100 connects the VLC network directly to the Internet, company servers, other resources, or combinations thereof. In one embodiment, Power-Line communications (PLC) are available using the communications backbone 100 anywhere in the building where AC electrical power is available. In some embodiments, this provides a technological improvement to the VLC service since a VLC access point 130 is located in a device that is normally coupled to an AC power source (e.g., a light fixture). Light fixtures can supply AC power to any type of light source including an LED light source, a tungsten light source, a computer backlight, a TV screen backlight, a lighted sign, and any other source of light that can be modulated at the VLC device's OSI physical layer (i.e., the light emitter and/or receiver).

The disclosed VLC Network System presented herein solves the technical problem of the “separate system” requirement (of technologies such as RFID that require a separate host RFID reader) since visible light communications (VLC) and Power-Line communications (PLC) interfaces can be integrated in the same device. A device such as the STMICROELECTRONICS STLUX chip can be used to modulate the light source and communicate with PLC devices such as the STMICROELECTRONICS ST2100 system on chip (SoC).

In another embodiment, the communications backbone 100 may also be Ethernet. Ethernet connectivity is an available function in the STMICROELECTRONICS ST2100 SoC and in other broadband communication systems. In some embodiments, the communications backbone 100 implements IEEE 1905.1-2013 and IEEE P1905.1a hybrid protocol features to communicate between different technologies such as PLC 135, Wi-Fi 140, and MoCA 150. The protocol implementations enable the backbone 100 to communicate between any type of sub-network that supports the profile and location concatenation presented herein.

Some embodiments of the disclosed VLC Network System enable detection and communication of a portable device's location within a room with varying levels of precision. In one embodiment, the VLC-enabled portable device is arranged to determine its location in the room 120 with substantial precision (e.g., within 2-3 meters, within 2-3 centimeters, or within 2-3 millimeters). In other embodiments, location information is coarse location information such as whether the portable device 125a is moving in the room (i.e., vector and movement information).

In one embodiment of the VLC Network System associated with e-Health, an elderly person wears an inexpensive VLC tag. In this implementation, the VLC access points 130a, 130b are able to detect the presence and movement of the VLC tag in the VLC transmission zone 220. In some implementations, communication with the VLC access point may be simple association (i.e., presence/location) detection by the VLC access point.

In some embodiments, the location information that is ascertained from the VLC Network System may be used to turn lights on, open doors/windows for those who have physical infirmities, save energy, or for other purpose(s). In other embodiments, a lack of movement may generate an alert for health professionals (due to a risk of fall, heart attack, respiratory disorder, or other emergency health issue). In these and other situations, the VLC tag may also transmit biological data to network applications. In still other embodiments, the VLC-enabled portable device can sense the VLC access point's position and communicate the position to the access point.

In some embodiments of the VLC Network System, more precise location information may be ascertained that includes the actual position of the VLC-enabled portable device in three dimensional space (as well as time information). The position information may also include rotation, direction, velocity, other positional data, or combinations thereof. In some embodiments, polarized lighting is used to determine location or other information such as rotation. Additionally, in some embodiments, triangulation or other algorithms may be applied in either the portable device or the access point. The location data may be used in the device and/or transmitted to an application. Furthermore, in some embodiments, the access point determines a relative position of a portable device and supplies the data to the VLC Network System, to a mobile device, to some other computing device, or combinations thereof.

There are known technical fields that may benefit from the locating functions of the VLC Network System, including the use of imaging arrays and polarized filters. Applications where these techniques are useful include safety applications and photography. Photography embodiments, for example, can use location versus time (i.e., velocity and acceleration) data to change lens speed. In these embodiments, direction information may enable an application to know what object in an image is being captured. Such information may also be used to determine that a picture is being taken out a window and an exposure adjustment is needed. Tagging a photograph with location, azimuth, altitude bearing, and other information can be used in a map such as “GOOGLE EARTH.” In these applications, the VLC Network System determines the location information, which improves value, simplifies use, and improves the experience of a user. Location information may be generated and used by the portable device, the access point, multiple access points, or combinations thereof.

In some embodiments, the VLC Network System contains simple, non-networked (e.g., peer to peer) VLC nodes, such as visible light beacons for assisting with location services. Some simple VLC nodes may, for example, only provide location information to the VLC-enabled portable device 125. Other simple VLC nodes provide information only to the VLC access point either in band or out of band. In other embodiments, the VLC Network System contains beacons that only provide location data to the VLC-enabled portable device 125.

The following standards documents are incorporated by reference herein in their entirety: IEEE Std 1901-2010™—IEEE Standard for Broadband over Power Line Networks: Medium Access Control and Physical Layer Specifications, New York, N.Y.: IEEE., IEEE Std 1905.1-2013—IEEE Standard for a Convergent Digital Home Network for Heterogeneous Technologies, IEEE Std P1905.1a—IEEE Standard for a Convergent Digital Home Network for Heterogeneous Technologies, Amendment: Support of new MAC/PHYs and enhancements, IEEE 802.15.7-2011—IEEE Standard for Local and Metropolitan Area Networks—Part 15.7: Short-Range Wireless Optical Communications Using Visible Light, and IEEE 802.11—IEEE Standard for Information Technology—Telecommunications and information exchange between systems local and metropolitan area networks family of standards.

Various aspects of the systems, methods, functions, steps, features and the like corresponding thereto disclosed herein may be implemented on one or more computer systems using hardware, software, firmware, circuits, or combinations thereof. Hardware, software, firmware, and circuits respectively refer to any hardware, software, firmware, or circuit component. Computer systems referred to herein may refer to any computing device and vice versa (e.g., smartphone, mobile computing device, personal data assistant, tablet computer, laptop computer, desktop computer, other computing device, and the like). For example, each computer system or computing device in the systems described herein or any embodiment of a system disclosed herein may utilize one or more of the following components: a single-core or multi-core hardware processor (e.g., central processing unit or graphics processing unit) on which software instructions are executed (e.g., instructions corresponding to an operating system, an application program, an interpreter such as a virtual machine, or a compiler); a memory associated with and in connection with the hardware processor such as cache or other system memory that stores software instructions or other data that the hardware processor may access for processing; an input device (e.g., mouse, keyboard, touchscreen, and the like); an output device (e.g., display, touchscreen, printer, and the like); a network or communication interface that enables the computer system to communicate over a network or communication protocol; and an application program having corresponding software instructions that are executable by a hardware processor. Connections between different computer systems and connections between different computer system components may be wired or wireless.

Virtualization computing techniques, cloud computing techniques, web application/website computing techniques, traditional and adaptive streaming techniques, and other computing techniques may be implemented by any embodiment of a system disclosed herein to enable and/or enhance the teachings described herein. For example, in a cloud computing embodiment, one or more servers (i.e., one or more computer systems) may store and execute software instructions corresponding to an application program based on input data received from client devices. In response to the input data received, the application program is executed accordingly, which results in graphical data being processed and output to the client devices for display on a display such as a touch screen on a smartphone or tablet computer.

As another example, in a web application or website embodiment, data representative of a user input may be transmitted to a server (i.e., a computer system) hosting the website for processing and storage in memory. In an application program embodiment, the application may be stored and executed locally on a user's computer system. In other embodiments, one or more components of the application program may be stored and executed on a server and the user's computer system. For example, a user may download the application program from an app store for an Android computing device, Blackberry computing device, Apple computing device, Windows computing device, Samsung computing device, other computing device, and the like. Execution of the application program on the user's computing device may require that the device transmit and receive data to and from one or more computing devices such as a server or other user's computing device. For example, an application may be downloaded from a server to a mobile device. Upon installation, the mobile device may communicate with a server.

One or more embodiments of the systems disclosed herein may utilize streaming technology. Streaming data enables data to be presented to the user of the client device while the client device receives data from the server. Streaming data from servers to client devices (e.g., computing devices operated by users) over a network is typically limited by the bandwidth of the network, or alternatively, the physical layer net bitrate. Traditional streaming protocols, such as RTSP (Real-Time Streaming Protocol), MS-VVMSP (Windows Media HTTP Streaming Protocol), and RTMP (Real-Time Messaging Protocol) may be implemented, which essentially send data in small packets from the server to the client device in real-time at the encoded bitrate of the data. Adaptive streaming may also be implemented. Adaptive streaming almost exclusively relies on HTTP for the transport protocol. Similar to traditional streaming, data is encoded into discrete packets of a particular size; however, the source data is encoded at multiple bitrates rather than a single bitrate. The data packets corresponding to the same data encoded at different bitrates are then indexed based on the bitrate in memory. This streaming method works by measuring, in real-time, the available bandwidth and computer capacity of the client device, and adjusts which indexed data packet to transfer based on the encoded bitrate.

One or more aspects of the systems disclosed herein may be located on (i.e., processed, stored, executed, or the like; or include one or more hardware or software components) a single computer system or may be distributed among a plurality of computer systems attached by one or more communication networks (e.g., internet, intranet, a telecommunications network, and the like). One or more components of a computer system may be distributed across one or more computer systems in communication with the computer system over a communication network. For example, in some embodiments, the systems disclosed herein may utilize one or more servers (i.e., one or more computer systems dedicated for a particular purpose in the system) that may be dedicated to serve the needs of one or more other computer systems or components across a communication network and/or system bus. The one or more servers may provide a central processing location for one or more aspects of the systems disclosed herein.

Those of ordinary skill in the art will appreciate that one or more circuits and/or software may be used to implement the system and methods described herein. Circuits refer to any circuit, whether integrated or external to a processing unit such as a hardware processor. Software refers to code or instructions executable by a computing device using any hardware component such as a processor to achieve the desired result. This software may be stored locally on a processing unit or stored remotely and accessed over a communication network.

As disclosed herein, a processor may refer to any hardware processor or software processor. A software processor may include or otherwise constitute an interpreter that is executed by a corresponding hardware processor. A computer system according to any embodiment disclosed herein is configured to perform any of the described functions related to the various embodiments of the systems disclosed herein.

As disclosed herein, the phrase “executed by a computing device” includes execution by any hardware component (e.g., CPU, GPU, network interface, integrated circuits, other hardware components, and the like) of the computing device such as a hardware processor. Any module may be executed by a computing device (e.g., by a processor of the computing device). Any method, function, step, feature, result, and the like disclosed herein may be implemented by one or more software modules whether explicitly described or not. Individual components within a computing device may work together to accomplish a desired method, function, step, feature, or result. For example, a computing device may receive data and process the data. A simple example would be that a network interface receives the data and transmits the data over a bus to a processor.

Various aspects of the systems disclosed herein may be implemented as software executing in a computer system. The computer system may include a central processing unit (i.e., a hardware processor) connected to one or more memory devices, a graphical processing unit, input devices such as a mouse and keyboard, output devices such as speakers and a display, a network interface to connect to one or more other computer systems (e.g., one or more computer systems configured to provide a service such that function as a database), an operating system, a compiler, an interpreter (i.e., a virtual machine), and the like. The memory may be used to store executable programs and data during operation of the computer system. The executable programs may be written in a high-level computer programming language, such as Java or C++. Of course, other programming languages may be used since this disclosure is not limited to a specific programming language or computer system. Further, it is to be appreciated that the systems and methods disclosed herein are not limited to being executed on any particular computer system or group of computer systems.

Some methods, functions, steps, or features have been described as being executed by corresponding software by a processor. It is understood than any methods, functions, steps, features, or anything related to the systems disclosed herein may be implemented by hardware, software (e.g., firmware), or circuits despite certain methods, functions, steps, or features having been described herein with reference to software corresponding thereto that is executable by a processor to achieve the desired method, function, or step. It is understood that software instructions may reside on a non-transitory medium such as one or more memories accessible to one or more processors in the systems disclosed herein. For example, where a computing device receives data, it is understood that the computing device processes that data whether processing the data is affirmatively stated or not. Processing the data may include storing the received data, analyzing the received data, and/or processing the data to achieve the desired result, function, method, or step. It is further understood that input data from one computing device or system may be considered output data from another computing device or system, and vice versa. It is yet further understood that any methods, functions, steps, features, results, or anything related to the systems disclosed herein may be represented by data that may be stored on one or more memories, processed by one or more computing devices, received by one or more computing devices, transmitted by one or more computing devices, and the like.

Certain words and phrases used in the specification are set forth as follows. As used throughout this document, including the claims, the singular form “a”, “an”, and “the” include plural references unless indicated otherwise. For example, “a” lighting control includes one or more lighting controls. Any of the features and elements described herein may be singular, e.g., a sensor may refer to one sensor and a memory may refer to one memory. The terms “include” and “comprise,” as well as derivatives thereof, mean inclusion without limitation. The term “or,” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation, such a device may be implemented in hardware, firmware, or software, or some combination of at least two of the same. The functionality associated with any particular controller may be centralized or distributed, whether locally or remotely. Other definitions of certain words and phrases are provided throughout this patent document. Those of ordinary skill in the art will understand that in many, if not most instances, such definitions apply to prior as well as future uses of such defined words and phrases.

A processor (i.e., a processing unit), as used in the present disclosure, refers to one or more processing units individually, shared, or in a group, having one or more processing cores (e.g., execution units), including central processing units (CPUs), digital signal processors (DSPs), microprocessors, micro controllers, state machines, and the like that execute instructions. The processors interchangeably refer to any type of electronic control circuitry configured to execute programmed software instructions. The programmed instructions may be high-level software instructions, compiled software instructions, assembly-language software instructions, object code, binary code, micro-code, or the like. The programmed instructions may reside in internal or external memory or may be hard-coded as a state machine or set of control signals. According to methods and devices referenced herein, embodiments describe software executable by the processor and operable to execute certain ones of the method acts.

In the present disclosure, memory may be used in a variety of configurations. As known by one skilled in the art, each memory comprises any combination of volatile and non-volatile, transitory and non-transitory computer-readable media for reading and writing. Volatile computer-readable media includes, for example, random access memory (RAM). Non-volatile computer-readable media includes, for example, read only memory (ROM), magnetic media such as a hard-disk, an optical disk drive, a flash memory device, a CD-ROM, and/or the like. In some cases, a particular memory is separated virtually or physically into separate areas, such as a first memory, a second memory, a third memory, and the like. In these cases, it is understood that the different divisions of memory may be in different devices or embodied in a single memory. The memory may be configured to store data.

In the alternative or in addition, the memory may be a non-transitory computer readable medium (CRM) wherein the CRM is configured to store instructions executable by a processor. The instructions may be stored individually or as groups of instructions in files. The files may include functions, services, libraries, and the like. The files may include one or more computer programs or may be part of a larger computer program. Alternatively or in addition, each file may include data or other computational support material useful to carry out the computing functions of the systems, methods, and apparatus described in the present disclosure.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

Generally, unless otherwise indicated, the materials for making the invention and/or its components may be selected from appropriate materials such as metal, metallic alloys, semiconductors, ceramics, plastics, etc.

The foregoing description, for purposes of explanation, uses specific nomenclature and formula to provide a thorough understanding of the disclosed embodiments. It should be apparent to those of skill in the art that the specific details are not required in order to practice the invention. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above-described exemplary embodiments, but should be defined only in accordance with the following claims and their equivalents.

What is claimed is:

1. A network system, comprising:
a network node;
at least one Visible Light Communications (VLC) portable device; and
a network interface coupled to the network node, the network interface including a VLC access point configured to receive light-based information from the at least one VLC portable device, wherein the VLC access point is further configured to determine location data about the at least one VLC portable device from the light-based information,
wherein the network node is configured to receive the location data, and wherein a parameter of the network system is modified in response to the location data.

2. The system of claim 1, wherein a plurality of VLC networks share a common location profile, the common location profile defining a transmission zone and the common location profile directing operations of portable devices when any of the VLC portable devices are communicatively associated with any of the respective VLC networks.

3. The system of claim 1, wherein a VLC-based profile for a first area is logically combined with another VLC-based profile for a second area during a provisioning process, wherein each VLC-based profile stipulates data associated with its respective area.

4. The system of claim 1, wherein a concatenation of VLC-based profiles with non-VLC-based profiles forms a hybrid technology network that permits broader transmission zones and capabilities coverage than only combining VLC-based profiles.

5. The system of claim 1, wherein a VLC-based profile is configured to enable a VLC portable device to access confidential data or restricted services due to the VLC portable device being verified to be in an area by an associated VLC access point.

6. The system of claim 5, wherein access to the confidential data or restricted services by the VLC portable device is withdrawn when the VLC portable device leaves the area.

7. The system of claim 1, wherein an associated VLC profile passes local content from a store having a VLC access point to a VLC portable device when the VLC portable device is in proximity of the store.

8. The system of claim 7, wherein the local content includes menus, advertisements, directories, promotions, coupons, inventory lists, store hours, listing of upcoming events, or combinations thereof.

9. The system of claim 1, wherein the VLC network system classifies all communications inside an area as secure after confirming a location of a VLC portable device in an area using a VLC access point.

10. The system of claim 1, wherein the VLC network system modifies network parameters for a VLC portable device after confirming a location of the VLC portable device in an area using a VLC access point.

11. The system of claim 9, wherein the network parameters include bandwidth priority, Quality of Service (QoS), prioritization (CoS), or combinations thereof.

12. The system of claim 1, wherein the VLC network system modifies parameters for a VLC-enabled portable device after confirming a location of the VLC-enabled portable device in an area using a VLC access point, wherein the modified parameters include service suspension of a smartphone, ringer disablement of a smartphone, restriction of permissible communication types of a smartphone, or combinations thereof.

13. The system of claim 1, wherein, after confirming a location and movement of a VLC-enabled portable device in an area, the VLC network system performs one or more actions in the area, including turning lights on or off, opening or closing doors, opening or closing windows, adjusting a temperature on a heater or air conditioner, or combinations thereof.

14. The system of claim 1, wherein the VLC network system generates an alert for health professionals after confirming a lack of movement in an area of a VLC-enabled portable device.

15. The system of claim 1, wherein the VLC network system transmits biological data to network applications after confirming a lack of movement in an area of a VLC-enabled portable device.

16. The system of claim 1, wherein a plurality of hybrid networks are interconnected by an IEEE 1905.1-enabled backbone network, wherein the plurality of hybrid networks share a common location profile, and wherein operations of the VLC portable devices associated with different access points in the plurality of hybrid networks are directed by the common location profile.

17. The system of claim 1, wherein a plurality of hybrid networks are interconnected by an IEEE 1905.1-enabled backbone network, wherein the plurality of hybrid networks share common location data, and wherein location-based services and data are distributed based on the common location data.

18. The system of claim 1, wherein the network interface supplies an IEEE 1905.1 protocol, a Power-Line broadband communications technology protocol, an Ethernet broadband communications technology protocol, a wireless Ethernet broadband communications technology protocol, or combinations thereof.

19. The system of claim 1, wherein a VLC light emitter/receiver is integrated in a light bulb, a television backlight, a cell phone backlight, or a portable computing device backlight.

20. The system of claim 1, wherein the VLC access point is in communication with an Internet backbone interface.

21. The system of claim 1, comprising: a VLC beacon communicatively associated with the VLC access point, the VLC beacon configured to emit a VLC signal identifying the VLC beacon to the at least one VLC portable device.

22. The system of claim 1, comprising: a VLC beacon communicatively separated from the VLC access point, the VLC beacon configured to emit a VLC signal identifying the VLC beacon and associated VLC beacon location data to the at least one VLC portable device.

23. The system of claim 1, wherein the location data enables identification of a physical transmission zone.

24. The system of claim 1, wherein the location data enables movement detection of the at least one VLC portable device within a physical transmission zone.

25. The system of claim 1, wherein the location data enables indicates location information associated with the at least one portable VLC device, and wherein the location information includes a location in a transmission zone, a direction of a movement, a velocity of the movement, an orientation, or combinations thereof, wherein the orientation includes rotation, azimuth, and altitude.

26. A network system, comprising:
a network node;
a network interface coupled to the network node, the network interface including a Visible Light Communications (VLC) access point; and
at least one VLC portable device, wherein the at least one VLC portable device is configured to determine location data using light-based information from the VLC access point, wherein the VLC portable device is further configured to communicate the location data to the network node,
wherein the network node is configured to communicate the location data to a software application.

27. A method of providing location based services using a network system, the method comprising:
providing a network node and a plurality of Visible Light Communications (VLC) portable devices;
communicatively associating a network interface with the network node, wherein the network interface includes a VLC access point;
receiving light-based information from at least one of the plurality of VLC portable devices via VLC access point;
determining location data about the at least one VLC portable device from the light-based information via VLC access point;
communicating the location data to the network node; and
modifying a parameter of the network system in response to the location data.
